(19) United States
(12) Patent Application Publication
(10) Pub. No.: US 2020/0369206 A1
(43) Pub. Date: Nov. 26, 2020

(54) DMS-BASED AUTOMATIC MIRROR ADJUSTMENT AND VALIDATION IN A VEHICLE

(71) Applicant: GM GLOBAL TECHNOLOGY OPERATIONS LLC, Detroit, MI (US)

(72) Inventors: Michael Baltaxe, Raanana (IL); Ruben Mergui, Ramat Gan (IL); Ron M. Hecht, Raanana (IL); Yael Shmueli Friedland, Tel Aviv (IL); Ariel Telpaz, Givat Haim Meuhad (IL); Shihchye A. Lin, Orlando, FL (US)

(21) Appl. No.: 16/421,437

(22) Filed: May 23, 2019

(51) Int. Cl. B60R 1/066; B60R 1/12; B60R 1/02; B60R 11/04; B60N 2/00; B60R 21/015

(52) U.S. Cl. CPC B60R 1/066; B60R 1/12; B60R 1/025; B60R 2001/1253; B60N 2/002; B60R 21/01538; B60R 11/04

(57) ABSTRACT

A vehicle, system and method of adjusting a mirror of a vehicle. A system for adjusting a mirror of a vehicle is disclosed. The system includes a calibration a calibration marker disposed on the vehicle, a camera, a motor and a processor. The calibration marker forms a calibration image onto a face of an occupant of the vehicle via reflection through the mirror. The camera obtains a camera image including the calibration image and the face of the occupant. The processor determines from the camera image an initial location of the calibration image at the face, determines a calibrated setting of the mirror that places the calibration image at a calibration location, and operates the motor to adjust the mirror to the calibrated setting.

### INTRODUCTION

The subject disclosure relates to adjusting mirrors on vehicles and, in particular, to a system and method for automatically adjusting a vehicle's mirror to the dimensions of an occupant of a driver's seat of the vehicle.

Having the correct mirror settings on a vehicle for a driver is beneficial for safe driving. Many times however, a driver enters a vehicle and forgets to adjust the rear-view and side view mirrors before driving. While some vehicles may have mirror settings that can be preset to correspond to different drivers, such systems are not sufficient when a driver changes sitting positions or when a new person is driving. Accordingly, it is desirable to provide a system for adjusting the mirror settings to the individual driver of the vehicle.

### SUMMARY

In one exemplary embodiment, a method of adjusting a mirror of a vehicle is disclosed. A calibration marker is reflected through the mirror to form a calibration image onto a face of an occupant of the vehicle. A processor determines an initial location of the calibration image at the face of the occupant. The processor operates a motor to adjust the mirror to a calibrated setting that places the calibration image at a selected location of the face.

In addition to one or more of the features described herein, the method further includes obtaining a camera image including the face of the occupant and the calibration image using a camera, and determining the initial location using the camera image. The method further includes validating a manually adjusted angle of the mirror to the calibrated setting for the mirror. The calibration marker is one or more LEDs disposed on the vehicle and the calibration image is an image of the one or more LEDs reflected through the mirror. The one or more LEDS generate at least one of a spatial pattern, a temporal pattern, and a color pattern. The method further includes recording an angular adjustment between the calibrated setting and an adjusted setting selected by the occupant during a selected time period after the mirror has been adjusted to its calibrated setting. The method further includes determining a relation between a position of the occupant and the angular adjustment and performing a subsequent calibration using the determined relation.

In another exemplary embodiment, a system for adjusting a mirror of a vehicle is disclosed. The system includes a calibration a calibration marker disposed on the vehicle, a camera, a motor and a processor. The calibration marker forms a calibration image onto a face of an occupant of the vehicle via reflection through the mirror. The camera obtains a camera image including the calibration image and the face of the occupant. The motor is configured to change a setting of the mirror. The processor is configured to determine from the camera image an initial location of the calibration image at the face, determine a calibrated setting of the mirror that places the calibration image at a calibration location, and operate the motor to adjust the mirror to the calibrated setting.

In addition to one or more of the features described herein, the processor is further configured to validate a manually adjusted angle of the mirror to the calibrated setting for the mirror. The calibration marker is one or more LEDs disposed on the vehicle and the calibration image is an image of the one or more LEDs reflected through the mirror. The one or more LEDS generate at least one of a spatial pattern, a temporal pattern, and a color pattern. The processor is further configured to record an angular adjustment between the calibrated setting and an adjusted setting selected by the occupant during a selected time period after the mirror has been adjusted to its calibrated setting. The processor is further configured to determine a relation between a position of the occupant and the angular adjustment and performing a subsequent calibration using the determined relation. The processor is further configured to performing a subsequent calibration by setting the initial angular setting of the mirror at a combination of a previously determined calibration setting and the angular adjustment.

In yet another exemplary embodiment, a vehicle is disclosed. The vehicle includes a calibration marker disposed thereon, a camera, a motor and a processor. The calibration marker forms a calibration image onto a face of an occupant of the vehicle via reflection through a mirror. The camera is configured to obtain a camera image including the calibration image and the face of the occupant. The motor is configured to change a setting of the mirror. The processor is configured to determine from the camera image an initial location of the calibration image at the face, determine a calibrated setting of the mirror that places the calibration image at a calibration location, and operate the motor to adjust the mirror to the calibrated setting.

In addition to one or more of the features described herein, the processor is further configured to validate a manually adjusted angle of the mirror to the calibrated setting for the mirror. The calibration marker is one or more LEDs disposed on the vehicle and the calibration image is an image of the one or more LEDs reflected through the mirror. The one or more LEDS generate at least one of a spatial pattern, a temporal pattern and a color pattern. The processor is further configured to record an angular adjustment between the calibrated setting and an adjusted setting selected by the occupant during a selected time period after the mirror has been adjusted to its calibrated setting. The processor is further configured to determine a relation between a position of the occupant and the angular adjustment and performing a subsequent calibration using the determined relation.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a plan view of an illustrative vehicle that includes a driving monitoring system (DMS) capable of making automatic adjustments to a mirror to suit the dimensions of a driver of the vehicle or other occupant;

FIG. 2 shows a camera image obtained of a driver of the vehicle;

FIG. 3 shows a plan view of the vehicle of FIG. 1 that highlights rear LEDs that form a calibration image at the driver via a rear view mirror;

FIG. 4 shows a view of an interior of a cabin of the vehicle;

FIG. 5 shows a plan view of the vehicle of FIG. 1 that highlights a left side LED and a right side LED;

FIG. 6 shows a perspective view of a left side view mirror;

FIG. 7 shows a flowchart illustrating a method performed to calibrate the azimuth angle and elevation angle of a side view mirror;

FIG. 8 shows a flowchart illustrating a method for adjusting a mirror of the vehicle;

FIG. 9 shows LED images forming a spatial pattern;

FIG. 10 illustrates a temporal pattern made by an LED to calibrate the mirror;

FIG. 11 illustrates use of a color frequency pattern to calibrate the mirror;

FIG. 12 shows a combination of the spatial, temporal and color frequency LEDs patterns of FIGS. 9, 10 and 11; and

FIG. 13 shows a display that can be shown at a monitor or dashboard to communicate to the driver.

### DETAILED DESCRIPTION

The following description is merely exemplary in nature and is not intended to limit the present disclosure, its application or uses. It should be understood that throughout the drawings, corresponding reference numerals indicate like or corresponding parts and features.

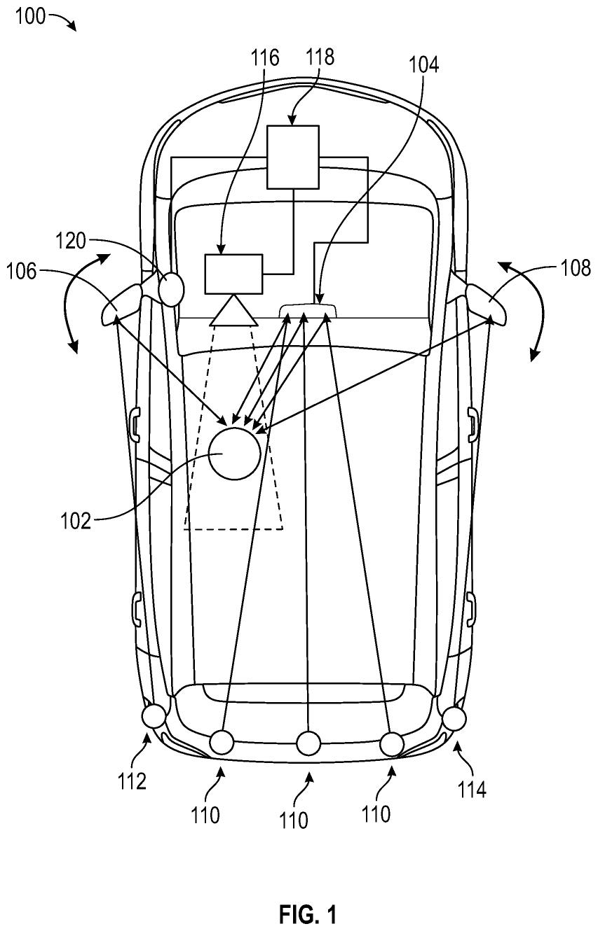

In accordance with an exemplary embodiment, FIG. 1 shows a plan view of an illustrative vehicle 100 that includes a driving monitoring system (DMS) capable of making automatic adjustments to a mirror to suit the dimensions of a driver 102 of the vehicle 100 or other occupant. The driver 102 is shown at the driver location. The vehicle 100 includes a rear view mirror 104, a left side view mirror 106 and a right side view mirror 108. The vehicle 100 further includes one or more calibration markers disposed on the vehicle that form an image at a face of the driver 102 through one or more of the rear view mirror 104, the left side view mirror 106 and the right side view mirror 108. A calibration marker can include a light source such as an LED light source in various embodiments. As shown in FIG. 1, the calibration markers include rear LEDS 110 that are used to calibrate the rear view mirror 104, left side LED 112 that is used to calibrate the left side view mirror 106 and right side LED 114 that is used to calibrate the right side view mirror 108.

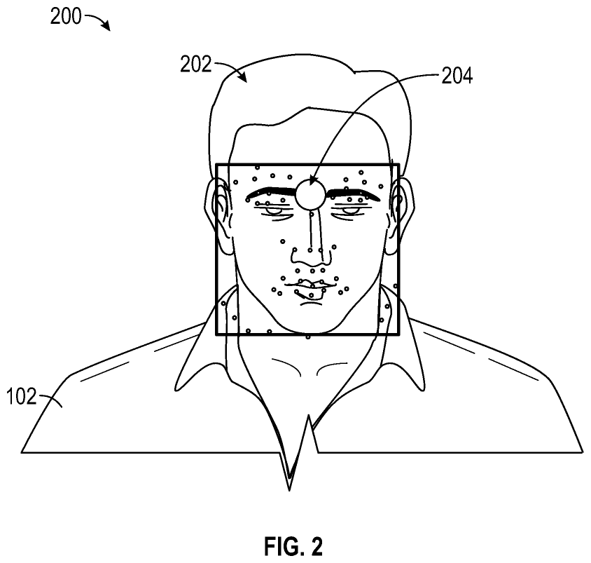

The vehicle 100 further includes a camera 116 for obtaining a camera image 200, FIG. 2 of the occupant 102. The camera 116 can be a digital camera and provides the camera image to a processor 118 that performs various operations disclosed herein for calibrating the mirrors. The processor 118 controls operation of motors that are associated with the mirrors in order to change various angular positions of the mirrors appropriately. While any mirror that can be adjusted to its calibrated setting using the methods disclosed herein will have an associated motor, only motor 120 associated with the left side view mirror 106 is shown for illustrative purposes. A mirror can also have a sensor (not shown) for recording an angle or angular adjustment at the mirror.

FIG. 2 shows a camera image 200 obtained of a driver 102 of the vehicle 100. The camera image 200 includes both the face 202 of the driver 102 as well as a calibration image 204 resulting from reflection of at least one of the rear LEDs 110, left side LED 112 and right side LED 114 through the rear view mirror 104, the left side view mirror 106 and the right side view mirror 108, respectively. When the selected mirror is calibrated or is at its calibrated setting, the calibration image 204 can be found at a selected location on the face 202 of the driver 102. For more than one LED, multiple LED images form a selected pattern on the face 202 of the driver 102. The calibration image 204 can be moved across the face 202 of the driver by adjusting the appropriate mirrors 104, 106, 108. The processor 118 receives the camera image 200 and locates various outline points of the face 202 of the driver 102. The processor 118 can then determine a proper location, or calibration location, for the image of the calibration marker on the face 202 of the driver and control the appropriate motor to adjust the appropriate mirror.

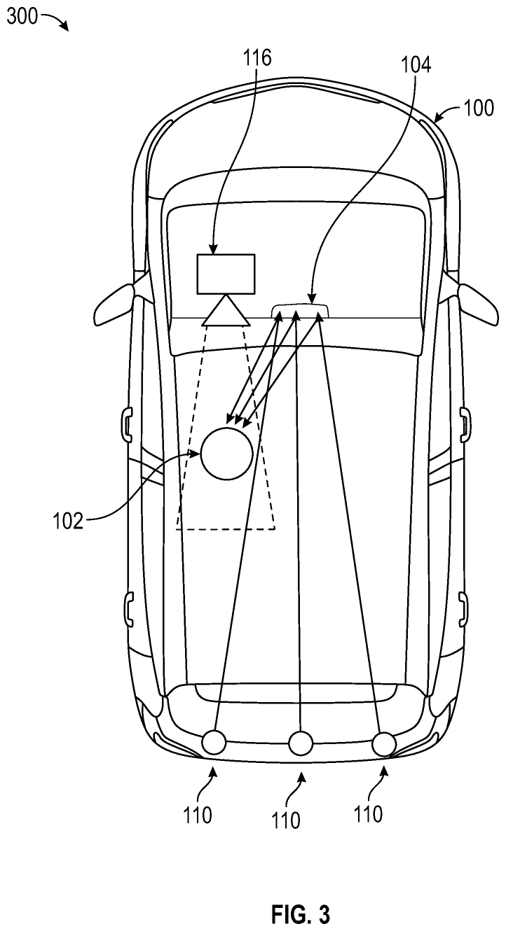

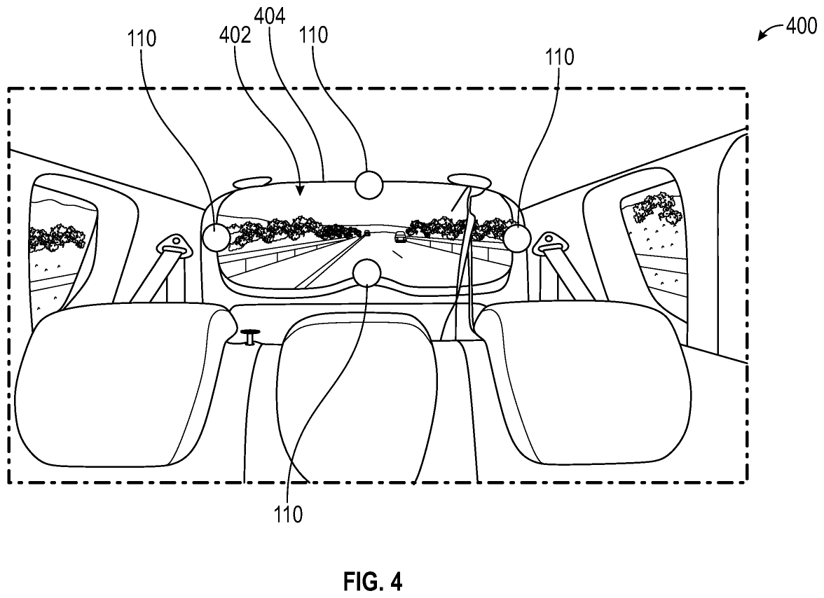

FIG. 3 shows a plan view 300 of the vehicle 100 that highlights rear LEDs 110 that form a calibration image at the driver via the rear view mirror 104. The rear LEDs 110 are disposed at a rear window 402 of the vehicle 100. A view 400 of the interior of a cabin of the vehicle 100, looking towards a back of the vehicle from the front is illustrated in FIG. 4. The rear LEDs 110 are placed at a frame 404 of the rear window 402. In a particular embodiment, rear LEDs 110 are placed at a top center, right side, left side and bottom center. When the rear LEDs 110 are illuminated, they form calibration image 204 at the face of the driver in the form of four points of light. These four image points can be centered at the eyes of the driver via the processor 118.

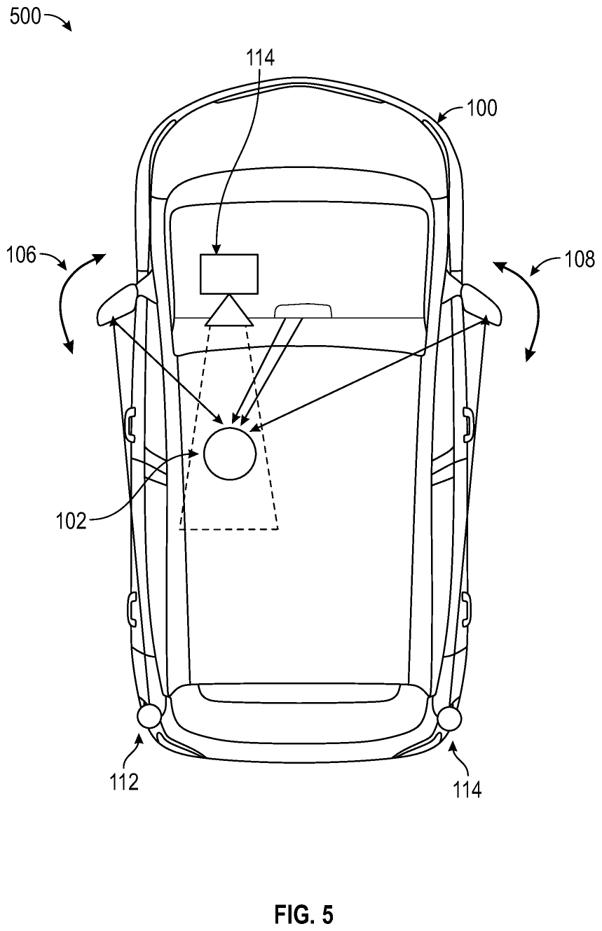

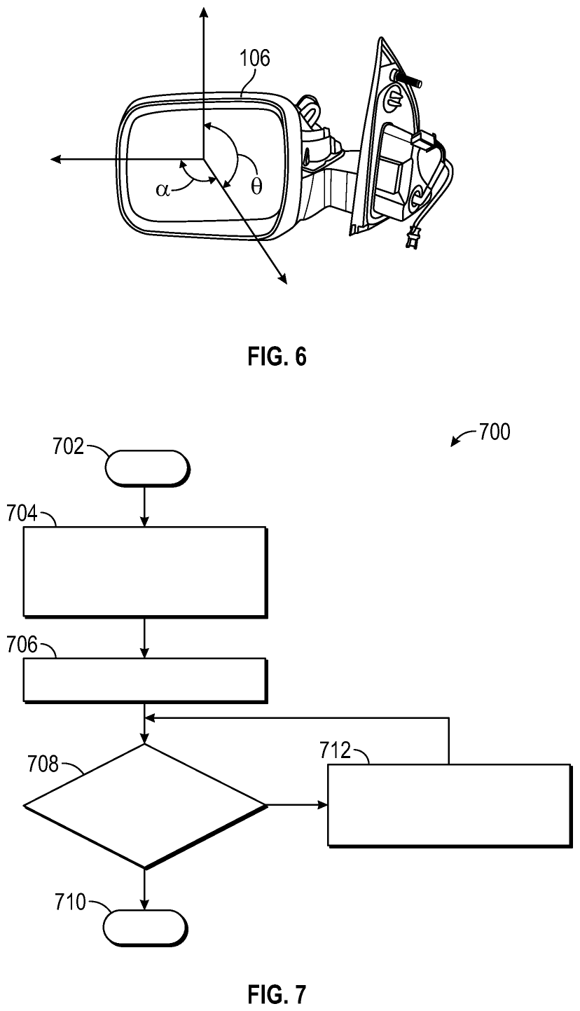

FIG. 5 shows a plan view 500 of the vehicle 100 that highlights left side LED 112 and right side LED 114 which form calibration images at the driver via left side view mirror 106 and right side view mirror 108, respectively. The left side LED 112 and right side LED 114 are installed at the rear end of the vehicle and mark the extreme sections of the vehicle 100 that should be visualized by the driver. FIG. 6 shows a perspective view of a left side view mirror 106, illustrating angular adjustments that can be made. A coordinate system centered at the left side view mirror 106 demonstrates an azimuth angle α and an elevation angle θ. A similar coordinate system is associated with the right side view mirror 108.

FIG. 7 shows a flowchart 700 illustrating a method performed to calibrate the azimuth angle α and elevation angle θ of one of the left side view minor 106 and right view side mirror 108. The method begins in box 702. In box 704, the LED for a selected side view mirror is illuminated. For example, the left side LED 112 is illuminated to calibrate the left side view mirror 106 and the right side LED 114 is illuminated to calibrate the right side view minor 108. In box 706, the adjustment angles of the minor are initialized, for example by setting them to zero, e.g., α=0 and θ=0. In box 708, the camera 116 obtains a camera image 200 and provides the camera image to the processor 118. The processor 118 determines the facial features of the driver and the location of the LED image on the face of the driver to determine whether the LED image is at its calibrated location on the face of the driver. If the LED image is at its calibration location, then the method ends at box 710. Returning to box 708, if the LED image is not at its calibration location, the method continues to box 712. At box 712, the processor incrementally advances the adjustment angles α and θ in a selected manner. Once the adjustment is made, the method returns to box 708, at which it is determined whether the newly adjusted location of the calibration image is at the calibration location. Boxes 708 and 712 therefore perform a loop that advances the adjustment angles to form a full sweep of the angular space of the minor until the LED image is located at its calibration location.

In one embodiment, the processor 118 adjusts the mirrors using the methods disclosed herein. In another embodiment, in addition to adjusting the mirror using the calibration markers as disclosed, the processor 118 can observe any additional adjustments made to the mirror by the driver over a set time period following the calibration process. In various embodiments, the set time period is about five minutes, although any selected time period can be used. The adjustments made by the driver can then be recorded and used in a subsequent calibration process. The method of including driver's adjustments is discussed below.

After the calibration procedure by the processor 118, a minor is set to its calibrated angles αₛ and θₛ. The processor 118 records any changes to the mirror angles during a selected time period after the calibration process. Let Δα and Δθ represent the change in the mirror angle that is performed manually by the driver during the selected time period following the calibration process. These angles Δα and Δθ represent a difference between a calibrated setting resulting from the calibration process and an adjusted setting selected by the driver. Let x, y, z be the average location of the driver in space, as recorded by the camera 116 and determined by processor 118. These variables can be measured for a plurality of times. The processor then builds vectors A, Θ, X, Y, Z that contain the historic values of Δα, Δθ, x, y, z measured during and after previous calibration processes.

The processor uses the vectors A, Θ, X, Y, Z to generate a model using, for example, linear regression, regression trees, or other suitable method. The model fits a pair of functions f and g, such that f forms a relation between driver position and change in azimuth angle f and g forms a relation between driver position and change in elevation angle as shown in Eq. (1) and (2):

f: (x, y, z)→Δα Eq. (1)

g: (x, y, z)→Δθ Eq. (2)

During a subsequent automatic mirror calibration process, the processor 118 sets the initial mirror angles to α and θ, where

α=αₛ+f(x, y, z) Eq. (3)

and

θ=θₛ+g(x, y, z) Eq. (4)

Therefore, the initial mirror angles α and θ in subsequent adjustment procedures include the calibration angles αₛ and θₛ generated by the calibration process and the driver's own manual adjustments Δα and Δθ.

In an embodiment in which a motor does not make adjustments to the mirror, the processor can record a manual adjustment made to the mirror and validate a resulting angle of the mirror with calibrated values, thereby validating the manual adjustment.

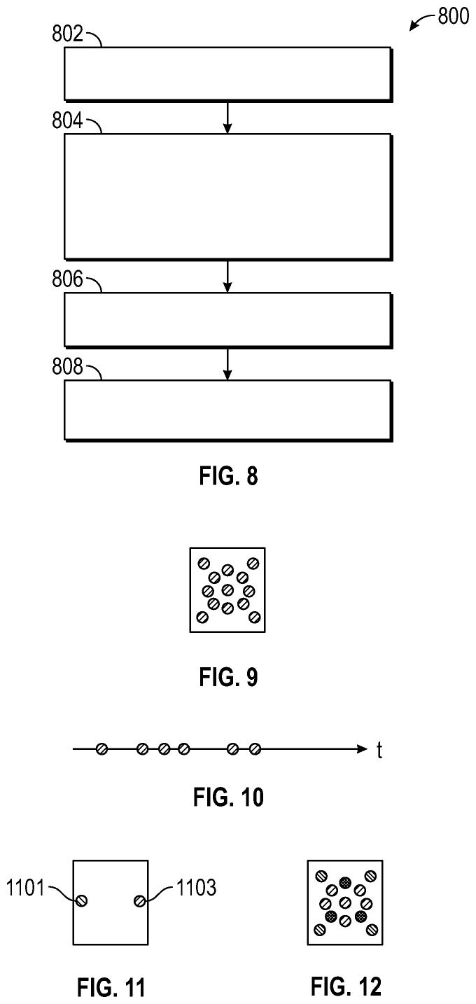

FIG. 8 shows a flowchart 800 illustrating a method for adjusting a mirror of the vehicle 100. In box 802, the mirror angles are adjusted using an automatic calibration method based on a location of a calibration image on a face of the driver. In box 804, the processor 118 observes a manual change or adjustment in the mirror angles by the driver during a selected time period after completion of the automatic calibration. In box 806, one or more vectors are built that contain the manual adjustments made by the driver. In box 808, a model is determined that fits the driver location to the driver's manual adjustments, to be used in future automatic calibration operations.

FIGS. 9-12 show various LED images that can be used to calibrate one or more mirrors. FIG. 9 shows LED images forming a spatial pattern. A spatial pattern can be used to avoid or prevent confusion that can occur when only a single LED is used. The pattern can be a custom pattern. The pattern is detected at the processor 118 using various techniques like single shot multi-box detection, blob detection and geometric hashing, a Hough transform, etc.

FIG. 10 illustrate a temporal pattern that can be made by an LED to calibrate the mirror. The LED can be turned on and off in a specific temporal pattern. The single LED pattern can be detected on a frame by frame basis at the processor 118, using such techniques as a blob detection, Hough transform, etc. The time signal corresponds to the frame sequence which can be matched with an expected temporal pattern.

FIG. 11 illustrates use of a color frequency pattern to calibrate the mirror. A first LED 1101 having a first color and a second LED 1103 having a second color are shown for illustrative purposes, although any number of colors can be used in various embodiments. With this pattern type, more than one LED is used and the LEDs display different colors. This pattern does not require a temporal modulation and can be implemented using a minimal number of LEDS, i.e., two LEDs.

FIG. 12 shows a combination of the spatial, temporal and color frequency LEDs patterns of FIGS. 9, 10 and 11.

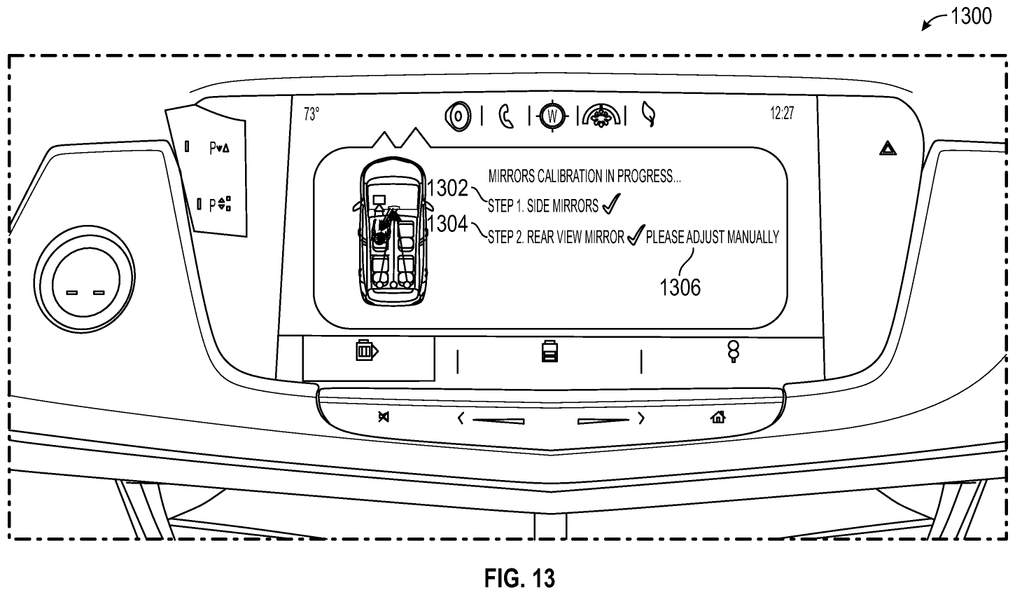

FIG. 13 shows a display 1300 that can be shown at a monitor or dashboard providing awareness and instructions to the driver. The display 1300 communicates completion of the automatic calibration process (via statements 1302 and 1304) and also instructs the driver (via instruction 1306) to make any manual adjustments that are suitable for the driver once the automatic calibration process is complete.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of adjusting a mirror of a vehicle, comprising:
reflecting a calibration marker through the mirror to form a calibration image onto a face of an occupant of the vehicle;
determining, via a processor, an initial location of the calibration image at the face of the occupant; and
operating, via the processor, a motor to adjust the mirror to a calibrated setting that places the calibration image at a selected location of the face.

2. The method of claim 1, further comprising obtaining a camera image including the face of the occupant and the calibration image using a camera, and determining the initial location using the camera image.

3. The method of claim 1, further comprising validating a manually adjusted angle of the mirror to the calibrated setting for the mirror.

4. The method of claim 1, wherein the calibration marker is one or more LEDs disposed on the vehicle and the calibration image is an image of the one or more LEDs reflected through the mirror.

5. The method of claim 4, wherein the one or more LEDS generate at least one of: (i) a spatial pattern; (ii) a temporal pattern; and (iii) a color pattern.

6. The method of claim 1, further comprising recording an angular adjustment between the calibrated setting and an adjusted setting selected by the occupant during a selected time period after the mirror has been adjusted to its calibrated setting.

7. The method of claim 6 further comprising determining a relation between a position of the occupant and the angular adjustment and performing a subsequent calibration using the determined relation.

8. A system for adjusting a mirror of a vehicle, comprising:
a calibration marker disposed on the vehicle that forms a calibration image onto a face of an occupant of the vehicle via reflection through the mirror;
a camera configured to obtain a camera image including the calibration image and the face of the occupant;
a motor configured to change a setting of the mirror; and
a processor configured to:
determine from the camera image an initial location of the calibration image at the face;
determine a calibrated setting of the mirror that places the calibration image at a calibration location; and
operate the motor to adjust the mirror to the calibrated setting.

9. The system of claim 8, wherein the processor is further configured to validate a manually adjusted angle of the mirror to the calibrated setting for the mirror.

10. The system of claim 8, wherein the calibration marker is one or more LEDs disposed on the vehicle and the calibration image is an image of the one or more LEDs reflected through the mirror.

11. The system of claim 10, wherein the one or more LEDS generate at least one of: (i) a spatial pattern; (ii) a temporal pattern; and (iii) a color pattern.

12. The system of claim 8, wherein the processor is further configured to record an angular adjustment between the calibrated setting and an adjusted setting selected by the occupant during a selected time period after the mirror has been adjusted to its calibrated setting.

13. The system of claim 12, wherein the processor is further configured to determine a relation between a position of the occupant and the angular adjustment and performing a subsequent calibration using the determined relation.

14. The system of claim 13, wherein the processor is further configured to perform a subsequent calibration by setting the initial angular setting of the mirror at a combination of a previously determined calibration setting and the angular adjustment.

15. A vehicle, comprising:
a calibration marker disposed on the vehicle that forms a calibration image onto a face of an occupant of the vehicle via reflection through a mirror;
a camera configured to obtain a camera image including the calibration image and the face of the occupant;
a motor configured to change a setting of the mirror; and
a processor configured to:
determine from the camera image an initial location of the calibration image at the face;
determine a calibrated setting of the mirror that places the calibration image at a calibration location; and
operate the motor to adjust the mirror to the calibrated setting.

16. The vehicle of claim 15, wherein the processor is further configured to validate a manually adjusted angle of the mirror to the calibrated setting for the mirror.

17. The vehicle of claim 15, wherein the calibration marker is one or more LEDs disposed on the vehicle and the calibration image is an image of the one or more LEDs reflected through the mirror.

18. The vehicle of claim 17, wherein the one or more LEDS generate at least one of: (i) a spatial pattern; (ii) a temporal pattern; and (iii) a color pattern.

19. The vehicle of claim 15, wherein the processor is further configured to record an angular adjustment between the calibrated setting and an adjusted setting selected by the occupant during a selected time period after the mirror has been adjusted to its calibrated setting.

20. The vehicle of claim 20, wherein the processor is further configured to determine a relation between a position of the occupant and the angular adjustment and performing a subsequent calibration using the determined relation.
